(19) United States
(12) Patent Application Publication
(10) Pub. No.: US 2016/0347986 A1
(43) Pub. Date: Dec. 1, 2016

(54) Degradable Fluid Sealing Compositions Incorporating Non-Degradable Microparticulates And Methods For Use Thereof

(71) Applicant: Halliburton Energy Services, Inc., Houston, TX (US)

(72) Inventors: Philip D. Nguyen, Houston, TX (US); Janette Cortez Montalvo, Kingwood, TX (US); James William Ogle, Spring, TX (US)

(73) Assignee: Halliburton Energy Services, Inc., Houston, TX (US)

(21) Appl. No.: 15/114,549

(22) PCT Filed: May 13, 2014
(86) PCT No.: PCT/US14/37784

§ 371 Date: Jul. 27, 2016

(51) Int. Cl. C09K 8/516; C09K 8/514; E21B 43/26; E21B 33/138; E21B 21/00; E21B 37/00; C09K 8/512; C09K 8/508

(52) U.S. Cl. CPC C09K 8/516; C09K 8/512; C09K 8/514; C09K 8/5086; E21B 33/138; E21B 21/003; E21B 37/00; E21B 43/26; C09K 2208/18

(57) ABSTRACT

It can sometimes be desirable to form a temporary fluid seal in a subterranean formation in conjunction with performing various subterranean operations. Methods for forming a temporary fluid seal in a subterranean formation can comprise: providing a sealing composition that comprises a plurality of degradable particulates and a plurality of water-insoluble microparticulates; introducing the sealing composition into a subterranean formation; and forming a degradable fluid seal with the sealing composition in the subterranean formation, the water-insoluble microparticulates being substantially non-degradable. The temporary fluid seal can block or divert fluid flow in the subterranean formation.

### BACKGROUND

The present disclosure generally relates to methods and compositions for blocking or diverting a fluid in subterranean formation, and, more specifically, to methods and compositions for establishing a temporary fluid seal in a subterranean formation.

Treatment fluids can be used in a variety of subterranean operations. Such subterranean operations can include, without limitation, drilling operations, stimulation operations, production operations, remediation operations, sand control treatments and the like. As used herein, the terms “treat,” “treatment” and “treating” refer to any subterranean operation that uses a fluid in conjunction with achieving a desired function and/or for a desired purpose. Use of these terms does not imply any particular action by the treatment fluid or a component thereof, unless otherwise specified herein. Illustrative treatment operations can include, for example, fracturing operations, gravel packing operations, acidizing operations, scale dissolution and removal operations, consolidation operations, and the like.

When performing these or other subterranean treatment operations, it can sometimes be desirable to temporarily or permanently block or divert the flow of a fluid within at least a portion of the subterranean formation. The blocking or diversion of the fluid can itself be considered to constitute a treatment operation. Illustrative fluid blocking and diversion operations can include, without limitation, fluid loss control operations, kill operations, conformance control operations, relative permeability modifier treatments, and the like. The fluid that is blocked or diverted can be a formation fluid that is natively present in the subterranean formation, such as petroleum, gas, or water. In other instances, the fluid that is blocked or diverted can be a subterranean treatment fluid, including the types mentioned above. In some cases, treatment fluids can be made to be self-diverting, such that they are directed to a desired location within the subterranean formation.

Providing for effective fluid loss performance during subterranean treatment operations can be highly desirable. “Fluid loss,” as used herein, refers to the undesired migration or loss of fluids into an unwanted location of a subterranean formation and/or a particulate pack. Fluid loss can be problematic in a number of subterranean operations including, for example, drilling operations, fracturing operations, acidizing operations, gravel-packing operations, workover operations, chemical treatment operations, wellbore cleanout operations, and the like. In fracturing operations, for example, excessive fluid loss into the formation matrix can sometimes result in incomplete fracture propagation.

Diverting agents can function similarly to fluid loss control agents, but may involve a somewhat different approach. Diverting agents can be used to temporarily or permanently seal off a portion of the subterranean formation. By sealing off a portion of the subterranean formation, a treatment fluid can be diverted from a highly permeable portion of the subterranean formation to a lower permeability portion, for example. Zonal isolation may also be provided in a subterranean formation in a similar manner.

When only temporary blocking or diversion of a fluid in a subterranean formation is desired, a fluid seal within the subterranean formation can be removed to allow fluid flow to resume. In some cases, a cleanup operation can be conducted to remove the fluid seal after it is no longer necessary (e.g., after performing a treatment operation). Cleanup operations can add to the time and expense associated with producing a fluid from the subterranean formation. In other cases, a fluid seal in a subterranean formation may comprise a substance that is natively unstable, such that the fluid seal weakens over time and allows fluid flow to resume. The term “degradable” will be used herein to refer to substances that are innately unstable, particularly under the conditions present in a given subterranean formation, without reference to the specific degradation mechanism leading to their instability. Although various substances can be innately unstable under common subterranean formation conditions, many of the most environmentally benign degradable substances that are often used in subterranean formations can be exceedingly expensive, which can sometimes lead to prohibitively high treatment costs when significant quantities of a degradable substance are needed. Particularly when treating large wellbore areas with an expensive degradable substance, the cost of the degradable substance versus the benefits expected to be obtained from treatment may need to be thoroughly analyzed.

### BRIEF DESCRIPTION OF THE DRAWING

The following FIGURE is included to illustrate certain aspects of the present disclosure and should not be viewed as an exclusive embodiment. The subject matter disclosed is capable of considerable modifications, alterations, combinations, and equivalents in form and function, as will occur to one having ordinary skill in the art and the benefit of this disclosure.

FIG. 1 shows an illustrative schematic of a system that can deliver sealing compositions of the present disclosure to a downhole location, according to one or more embodiments.

### DETAILED DESCRIPTION

The present disclosure generally relates to methods and compositions for blocking or diverting a fluid in subterranean formation, and, more specifically, to methods and compositions for establishing a temporary fluid seal in a subterranean formation.

One or more illustrative embodiments incorporating the features of the present disclosure are presented herein. Not all features of a physical implementation are necessarily described or shown in this application for the sake of clarity. It is to be understood that in the development of a physical implementation incorporating the embodiments of the present disclosure, numerous implementation-specific decisions may be made to achieve the developer's goals, such as compliance with system-related, business-related, government-related and other constraints, which may vary by implementation and from time to time. While a developer's efforts might be time-consuming, such efforts would be, nevertheless, a routine undertaking for one having ordinary skill in the art and the benefit of this disclosure.

As discussed above, sealing compositions can be used in various ways in the course of conducting subterranean operations. In many instances, it can be desirable for a sealing composition to form a temporary fluid seal that remains intact for only a finite time in a subterranean formation. In order to accomplish the foregoing, a sealing composition comprising a degradable material may be used to provide a degradable fluid seal in the subterranean formation. The degradable material may be in a particulate form, thereby blocking pore throats and other porous features in the subterranean formation when forming a degradable fluid seal. Suitable degradable materials can include, for example, degradable polymers that innately breakdown under conditions that may be present in a particular subterranean formation. Alternately or in addition to innate breakdown, degradation can take place or be expedited by conducting a cleanout operation in the subterranean formation. Regardless of whether degradation takes place innately or via a cleanout operation, mechanisms whereby degradation may take place include, for example, depolymerization, chemical modification (including biologically induced chemical modifications), de-crosslinking, slow solubilization, any combination thereof, and the like.

Although degradable polymers can be successfully utilized in the course of performing various subterranean operations, their use is not without challenges. Specifically, many degradable polymers are expensive (>$1 per pound), particularly those that most readily undergo degradation and have a favorable environmental profile. As a result, degradable polymers can represent a significant portion of the cost associated with producing a fluid, such as a hydrocarbon resource, from a subterranean formation. The high cost of degradable polymers can make certain treatment operation configurations cost prohibitive to perform.

The present inventors discovered simple yet surprising techniques whereby the amount of degradable polymer needed to form an effective fluid seal in a subterranean formation may be significantly lowered. Specifically, the inventors found that by combining water-insoluble microparticulates and degradable particulates with one another in various ratios, the foregoing benefits could be realized. As used herein, the term “microparticulates” refers to particulate materials that are between about 1 micron and about 1000 microns in size. A number of water-insoluble microparticulates, many of which are available at very low cost, may be suitable for practicing the various embodiments described herein, thereby decreasing the overall cost of materials needed for forming a degradable fluid seal in a subterranean formation. Further disclosure regarding suitable microparticulates follows hereinbelow.

The inventors also established that the microparticulates not only allow the degradable particulates to be used more effectively in forming a degradable fluid seal, but they also do not significantly impact the seal's degradation process once the restoration of fluid flow is desired. That is, when the microparticulates are present in the fluid seal, the fluid seal may still degrade in substantially the same manner as if the microparticulates were not present. The microparticulates alone are not believed to provide the integrity needed to maintain an intact fluid seal, thereby not undesirably shutting off fluid flow irreversibly. Instead, once the degradable particulates degrade, the water-insoluble microparticulates are released from the fluid seal, thereby allowing fluid flow to resume without having to degrade the entirety of the fluid seal.

When employing only degradable particulates in forming a fluid seal, the sealing time afforded by the seal may be influenced by only a limited number of factors such as time, temperature, and exposed surface area. As used herein, the term “sealing time” refers to the time during which the fluid seal is actively blocking fluid flow in a subterranean formation. By including microparticulates in the fluid seal, the influence of the foregoing factors on the fluid seal's degradation rate can be altered to some degree, thereby providing another variable that can be adjusted to provide a desired sealing time. Without being bound by theory or mechanism, it is believed that the microparticulates may provide a greater exposed surface area of the degradable particulates, possibly accompanied by void formation in the fluid seal as degradation takes place, thereby promoting more rapid degradation. The increased degradation rate of the degradable particulates may be counterbalanced, at least to some degree, by the non-degradability of the microparticulates. Hence, it is believed that by adjusting the ratios of the components in the sealing composition, a fluid seal having a desired sealing time can be produced. Moreover, it is believed that the sealing composition can be tailored in the foregoing manner to suit the conditions present in a given subterranean formation (e.g., the type of formation matrix that is present, the temperature and chemistry of the formation, and the formation's porosity). Regardless of the sealing time ultimately obtained, the microparticulates do not particularly impact one's ability to remove the fluid seal and restore fluid flow within the subterranean formation, as discussed previously.

Another benefit that may be afforded by the water-insoluble microparticulates employed in the embodiments described herein is that they can often be easily produced from a subterranean formation after fluid seal degradation has occurred. In some embodiments, the ready production of the microparticulates may result from their relatively low density values. Not only are the microparticulates water-insoluble, but they are also insoluble in many other common treatment fluids and formation fluids. Accordingly, the microparticulates may be produced in a buoyant particulate form without significant dissolution in a produced fluid. Further, the produced microparticulates may be separated from a produced fluid without significantly increasing downstream refining costs. As a result of their ready production, the risk of the microparticulates remaining in the subterranean formation and inflicting damage therein can be significantly reduced. The small size of the microparticulates may also decrease the risk of their inflicting damage within the subterranean formation.

As a result of decreasing the amount of a degradable polymer needed to form an effective fluid seal, the cost of performing various treatment operations may be reduced. Moreover, by decreasing costs and allowing more effective use of the degradable polymer to take place, certain implementations of treatment operations that would otherwise be economically unfeasible can become an option for a well operator. For example, placement of a fluid seal over wider areas of a wellbore, such as over a long interval of a subterranean formation, may be economically feasible by employing the sealing compositions described herein. Subterranean operations necessitating the use of especially large treatment fluid volumes can also become much more economically feasible by employing the sealing compositions described herein.

In various embodiments, sealing compositions described herein can comprise a plurality of degradable particulates and a plurality of water-insoluble microparticulates. In various embodiments, the water-insoluble microparticulates can be substantially non-degradable. As used herein, the term “substantially non-degradable” refers to a general lack of chemical or physical changes over a given timeframe, such as the timeframe during which a plurality of microparticulates is used in forming an intact fluid seal.

In various embodiments, the water-insoluble microparticulates may constitute a rigid material, and the degradable particulates may constitute a substantially non-rigid material. As used herein, the term “rigid” refers to a particulate form that is substantially non-pliable and substantially retains its shape when subjected to stress. Conversely, a substantially non-rigid material can undergo some deformation when subjected to stress. It is believed that the deformability of a substantially non-rigid material can promote the initial formation of an effective fluid seal. Moreover, without being bound by theory or mechanism, it is believed that a rigid material may provide a non-deformable surface upon which a substantially non-rigid material may disperse when forming a fluid seal, thereby resulting in more effective use of the substantially non-rigid material.

The Vickers hardness test may be used as a common measure for determining the hardness or rigidity of a substance. This test determines the ability of a material to resist plastic deformation under an applied load, such as that provided by an indenter. Details regarding the Vickers hardness test and other measures of the rigidity of a substance will be familiar to one having ordinary skill in the art and will not be described in any further detail herein. In various embodiments, the microparticulates and degradable particulates used in the present sealing compositions can be characterized according to their Vickers hardness parameters, as further specified below. It is to be recognized that alternative measures of hardness or rigidity may also be used in characterizing the microparticulates and degradable particulates used in the sealing compositions described herein.

In some embodiments, the water-insoluble microparticulates may have a Vickers hardness ranging between about 3 GPa and about 70 GPa. In more particular embodiments, the water-insoluble microparticulates may have a Vickers hardness ranging between about 3 GPa and about 25 GPa, or between about 25 GPa and about 40 GPa, or between about 40 GPa and about 70 GPa. In still more particular embodiments, the water-insoluble microparticulates may have a Vickers hardness ranging between about 4 GPa and about 20 GPa.

In some embodiments, the degradable particulates may have a Vickers hardness of about 30 GPa or below. In more particular embodiments, the degradable particulates may have a Vickers hardness ranging between about 1 GPa and about 30 GPa, or between about 1 GPa and about 20 GPa, or between about 1 GPa and about 10 GPa, or between about 1 GPa and about 5 GPa, or between about 1 GPa and about 3 GPa. In some embodiments, the degradable particulates may have a Vickers hardness that is lower than the water-insoluble microparticulates. Accordingly, in some embodiments, the water-insoluble microparticulates may be more rigid than are the degradable particulates.

In various embodiments, the water-insoluble microparticulates may have a particle size ranging between about 0.1 micron and about 150 microns. The microparticulates are not believed to be particularly limited in shape, which may include various non-limiting forms such as, for example, platelets, shavings, flakes, ribbons, rods, strips, spheroids, ovoids, toroids, pellets, tablets, needles, powders and/or the like. The microparticulates may be solid or hollow, and they may have at least one dimension that resides within the above size range. Fibrous microparticulates (i.e., microfibers), for example, may have a diameter residing within the above size range, or within a size range of about 10 microns to about 150 microns, whereas the length of the microfibers may be much longer, even outside the microparticulate realm. Microbody particulates, in contrast, may have all their dimensions residing with a microparticulate size range (i.e., about 1 micron to about 1000 microns in size). As used herein, the term “microbody” refers to a three-dimensional solid that may be hollow or non-hollow. Hollow microbodies may also be referred to herein as “microbubbles” or “microballoons.” Hollow microbodies may be particularly advantageous due to their relatively low density values, which may allow them to be more easily produced from a subterranean formation, as discussed above.

Although other sizes of microparticulates may be used in conjunction with practicing the various embodiments described herein, water-insoluble microparticulates having at least one dimension in the range of about 0.1 micron to about 150 microns may convey particular advantages. Microparticulates within this size range can function readily in conjunction with degradable particulates when forming a degradable fluid seal. In addition, this size range may be natively suited for occluding the pore sizes that are commonly present in various subterranean formations. Moreover, microparticulates within this size range can be readily produced in various industrial processes, either by choice or as a waste product. Thus, suitable microparticulates for practicing the embodiments described herein may be obtained inexpensively and may help decrease the cost of treating a subterranean formation with the sealing compositions described herein.

In some embodiments, suitable microparticulates may comprise fly ash or be formed from fly ash. As used herein, the term “fly ash” refers to a solid product of combustion that rises with a flue of the combustion products. Most often, the term “fly ash” refers to the fine particulates that are formed during coal combustion, but it is to be recognized that fly ash can also be produced from other sources. Fly ash formed during coal combustion can comprise large amounts of silicon dioxide and calcium oxide. Fly ash represents a significant waste disposal issue in coal combustion processes. By utilizing fly ash or a product formed therefrom in a downstream process, such as by practicing the various embodiments described herein, advantageous benefits can be realized in the initial coal-burning process through lessening its waste burden. In many instances, the particle size of fly ash natively resides within the microparticulate size range, particularly within a range of about 1 micron to about 150 microns, thereby providing a readily available and inexpensive source of microparticulates suitable for practicing the various embodiments described herein. Sieving or other size-based separation techniques can optionally be performed on natively produced fly ash if a specific particle size distribution is needed. Because fly ash represents a substance that would otherwise constitute a waste product, it can often be acquired at a very low cost (pennies per pound).

In some or other embodiments, suitable microparticulates may comprise a particulate material selected from the group consisting of silica flour, fly ash, mica, polymer particulates, cured resin powders, a ceramic microbody, a glass microbody, and a microfiber (e.g., a microfiber having a diameter ranging between about 0.1 microns and about 150 microns), and any combination thereof. As used herein, the term “silica flour” refers to a fine particulate material comprising silicon dioxide that is produced by grinding sand or a like siliceous material. Suitable silica flours can include, for example, 325 mesh or 200 mesh silica flours. Glass and ceramic microbodies may include both solid and hollow three-dimensional structures.

Suitable ceramics that may be included in ceramic microbodies may include, for example, silicon carbide, aluminum carbide, boron carbide, any combination thereof, and the like. Suitable ceramic microbodies may include, but are not limited to, ceramic microspheres such as N-1000 or N-1200 Zeeospheres (Zeeospheres Ceramics, LLC, which contain a silicon-aluminum ceramic and have 95% of their particles less than 150 microns in size). Other commercially available ceramic microspheres may also be suitable, such as fly ash available from Zeeospheres Ceramics LLC, which is available in the exemplary size range noted above.

Suitable glass microbodies may include glass microspheres such as, but not limited, to HGS10000 and HGS18000 (3M Corporation), which have 95^{th} percentile diameters of 65 and 60 microns, respectively, and true density values of 0.63 g/cm³. Other commercially available glass microspheres may also be suitable.

Suitable microfibers can include, for example, carbon fibers, glass fibers, cellulose fibers, and the like. Suitable microfibers can have a length ranging between about 100 microns and about 3000 microns. In some embodiments, even longer microfibers may be used.

In some embodiments, the degradable particulates used in forming a degradable fluid seal may comprise a degradable polymer. A number of degradable polymers may be suitable for use in conjunction with the embodiments described herein. Suitable degradable polymers may include, for example, polysaccharides, proteins, polyesters (particularly aliphatic polyesters), poly(hydroxyalkanoates), poly(β-hydroxyalkanoates), poly(ω-hydroxy alkanoates), polylactides, polyglycolides, poly(ε-caprolactone)s, poly(hydroxybutyrate)s, poly(alkylene dicarboxylates), polyanhydrides, poly(hydroxy ester ether)s, poly(ether ester)s, poly(ester amide)s, polycarbamates (i.e., polyurethanes), polycarbonates, poly(orthoester)s, poly(amino acid)s, poly(ethylene oxide), polyphosphazenes, polyvinyl alcohol, methyl cellulose, ethyl cellulose, carboxymethyl cellulose, carboxyethyl cellulose, acetyl cellulose, hydroxyethyl cellulose, shellac, dextran, guar, xanthan, starch, a scleroglucan, a diutan, poly(vinyl pyrollidone), polyacrylamide, polyacrylic acid, poly(diallyldimethylammonium chloride), poly(ethylene glycol), polylysine, polymethacrylamide, polymethacrylic acid, poly(vinylamine), any derivative thereof, any copolymer thereof, any salt thereof, and any combination thereof. Copolymers may include random, block, graft, and/or star copolymers in various embodiments. In more particular embodiments, the degradable polymer may comprise a polylactide or an aliphatic polyester.

Degradation of the degradable polymer may take place by any mechanism of action. The degradation rate may depend at least in part on the backbone structure of the degradable polymer. In some embodiments, the degradation may be due to a chemical change, for example, that destroys or depolymerizes the polymer structure or that changes the solubility of the polymer such that it becomes more soluble than the parent polymer. For example, the presence of hydrolysable and/or oxidizable linkages in the polymer backbone may confer degradability to a polymer. In addition, exposure to conditions such as, for example, temperature, moisture, oxygen, microorganisms, enzymes, particular pH conditions, and the like may result in polymer degradation. The degradation rate may depend on factors such as, for example, the polymer repeat unit(s) and their sequence, the polymer length and molecular geometry, molecular weight, morphology (e.g., crystallinity, particle size, and the like), hydrophilicity/hydrophobicity, and exposed surface area. Knowing how the degradation rate may be influenced by various factors, one of ordinary skill in the art and the benefit of this disclosure will be able to choose an appropriate degradable polymer for a given application.

Various ratios of degradable particulates to the water-insoluble microparticulates may be used in practicing the present embodiments. As indicated above, adjusting the ratios of these two components may allow the degradation rate to be altered for a given application or a given set of formation conditions. In various embodiments, a mass ratio of the water-insoluble microparticulates to the degradable particulates can range between about 1:25 to about 4:1, particularly a range between about 1:4 to about 4:1. In some embodiments, approximately equal quantities of the water-insoluble microparticulates and the degradable particulates may be present.

In some embodiments, the sealing compositions described herein may be present in a treatment fluid. In various embodiments, the treatment fluid may comprise a carrier fluid. Suitable carrier fluids may comprise an aqueous carrier fluid or an oil-based carrier fluid. Suitable aqueous carrier fluids may include, for example, fresh water, salt water, brine (saturated salt water), seawater, produced water (i.e., subterranean formation water brought to the surface), surface water (e.g., lake or river water), and flow back water (i.e., water placed into a subterranean formation and then brought back to the surface). In various embodiments, an amount of the carrier fluid may be chosen such that the sealing composition can be effectively carried to a desired location in a subterranean formation.

In some embodiments, the carrier fluid may further comprise a crosslinked polymer. Without being bound by any theory or mechanism, the inclusion of a crosslinked polymer in the carrier fluid is believed to be beneficial due to its ability to increase the fluid's viscosity, thereby improving its ability to carry the various particulates of the sealing composition to a desired location. Suitable crosslinked polymers are not believed to be particularly limited and can include various base polymers that have been crosslinked with a suitable crosslinking agent. Suitable base polymers may include, for example, acrylamide polymers and copolymers, celluloses, guars, xanthan, scleroglucan, succinoglycan, diutan, any derivative thereof, any combination thereof, and the like. Suitable crosslinking agents may include, for example, metal ions, borates and organic crosslinking agents.

Depending on the intended function of a treatment operation being performed with a treatment fluid containing the sealing compositions described herein, other components may optionally be present. Such optional components may include, for example, salts, pH control additives, surfactants, foaming agents, antifoaming agents, breakers, biocides, crosslinkers, additional fluid loss control agents, stabilizers, chelating agents, scale inhibitors, gases, mutual solvents, particulates, corrosion inhibitors, oxidizing agents, reducing agents, antioxidants, relative permeability modifiers, viscosifying agents, proppant particulates, gravel particulates, scale inhibitors, emulsifying agents, de-emulsifying agents, iron control agents, clay control agents, flocculants, scavengers, lubricants, friction reducers, viscosifiers, weighting agents, hydrate inhibitors, consolidating agents, any combination thereof, and the like. A person having ordinary skill in the art and the benefit of this disclosure will recognize when such optional additives should be included in a treatment fluid, as well as the appropriate amounts to include.

In various embodiments, the sealing compositions described herein may be used in conjunction with various subterranean treatment operations. Such treatment operations may vary without limitation. Illustrative functions that may be performed by the sealing compositions in subterranean operations include, for example, fluid loss control, fluid diversion, conformance control, and the like.

In various embodiments, methods described herein may comprise: providing a sealing composition comprising a plurality of degradable particulates, and a plurality of water-insoluble microparticulates; introducing the sealing composition into a subterranean formation; and forming a degradable fluid seal with the sealing composition in the subterranean formation, the water-insoluble microparticulates being substantially non-degradable.

In some embodiments, the methods may further comprise performing a treatment operation in the subterranean formation while the degradable fluid seal is intact. As used herein, a fluid seal will be considered to be “intact” if it still at least partially reduces fluid loss to a subterranean formation or promotes fluid diversion. The treatment operation may be conducted with a treatment fluid being used to introduce the sealing composition to the subterranean formation or with a subsequently introduced treatment fluid.

In some embodiments, the methods described herein may further comprise allowing the degradable fluid seal to degrade or performing a cleanup operation to degrade the degradable fluid seal, after performing a treatment operation. Depending on the characteristics of the degradable particulates, one having ordinary skill in the art will be able to choose an appropriate cleanup fluid to promote degradation of the fluid seal. For example, in some embodiments, an acidic cleanup fluid may be introduced to the subterranean formation to promote removal of the fluid seal, if needed. Depending on the nature of the degradable polymer, suitable cleanup fluids may include acids, acid-generating compounds, bases, base-generating compounds, oxidants, enzymes and the like.

In some embodiments, the methods described herein may further comprise producing a fluid from the subterranean formation. The produced fluid may comprise a hydrocarbon resource that is present in the subterranean formation in some embodiments. Production from the subterranean formation may take place after forming the degradable fluid seal. If a subsequent treatment operation is performed, production may take place before the subsequent treatment operation, after the subsequent treatment operation, or both.

In some embodiments, the methods described herein may further comprise producing at least a portion of the water-insoluble microparticulates from the subterranean formation in a produced fluid, after the fluid seal has degraded or had a cleanup operation performed thereon. Production of the water-insoluble microparticulates may take place in any fluid that is being produced from the subterranean formation. As discussed above, the ability to produce the water-insoluble microparticulates from the subterranean formation may lessen the likelihood of their causing damage therein. In some embodiments, the water-insoluble microparticulates produced from the subterranean formation may be those resulting from degradation of the degradable fluid seal in the subterranean formation. For example, the water-insoluble microparticulates may be released from the fluid seal as the surrounding degradable polymer particulates degrade.

In other various embodiments, the water-insoluble microparticulates used in conjunction with forming the degradable fluid seal may be allowed to remain in the subterranean formation. Specifically, in some embodiments, the degradable fluid seal may be allowed to degrade or have a cleanup operation performed thereon, and the microparticulates liberated from the seal may, at least in part, remain within the subterranean formation. Allowing the microparticulates to remain within the subterranean formation may be desirable when more dense microparticulates, such as solid microbodies, are used, which may be less buoyant and not as readily transported to the earth's surface in a produced fluid. Although production of the water-soluble microparticulates may be desirable, it is believed that the microparticulates provide a low risk of inducing formation damage, even if they remain within the subterranean formation.

In some embodiments, methods described herein may comprise: combining in a carrier fluid a plurality of degradable particulates comprising a degradable polymer and a plurality of water-insoluble microparticulates, thereby forming a sealing composition; introducing the sealing composition into a subterranean formation; forming a degradable fluid seal with the sealing composition in the subterranean formation, the water-insoluble microparticulates being substantially non-degradable; performing a treatment operation in the subterranean formation while the degradable fluid seal is intact; and allowing the degradable fluid seal to degrade or performing a cleanup operation to degrade the degradable fluid seal.

As discussed above, the action of forming a degradable fluid seal in a subterranean formation may be considered to represent a treatment operation by itself. For example, it may be desirable to temporarily shut off production from an interval of a subterranean formation and then return the interval to production at a later time. In some or other embodiments, a further treatment operation may be performed while the degradable fluid seal is intact, where the further treatment operation accomplishes a different function over the act of forming the degradable fluid seal.

When used in conjunction with performing a further treatment operation in a subterranean formation, the sealing composition may be introduced into the subterranean formation in a pad fluid or a pill, followed by introducing the treatment fluid used for performing the further treatment operation. That is, the methods described herein may further comprise introducing a treatment fluid subsequent to a pad fluid or a pill containing the sealing composition. As used herein, the terms “pad fluid” and “pill” refer to a small volume of a specialized treatment fluid that is introduced ahead of a significantly larger volume of a treatment fluid that is not configured to perform the intended function of the pad fluid or pill. The pad fluid or pill can condition the subterranean formation for the subsequently introduced treatment fluid to perform its intended function. For example, in some embodiments, the pad fluid or pill may limit fluid loss to the subterranean formation or result in diversion of the treatment fluid to a location of the subterranean formation where it can perform its intended function. That is, in some embodiments, the methods described herein may further comprise diverting a subsequent treatment fluid (i.e., subsequent to a pad fluid or pill) with the degradable fluid seal. Other illustrative functions of the sealing composition may include, for example, temporarily shutting off perforations, formation of a temporary filter cake on the wellbore walls during drilling, fracturing or gravel packing, enhancing the creation of a complex fracturing network during fracturing operations, and the like.

In other various embodiments, the sealing composition may be introduced into the subterranean formation in the treatment fluid that is used in performing the treatment operation. Functions of the sealing composition in this regard may be similar to those discussed above when the sealing composition is present in a pad fluid or a pill. When present in a treatment fluid that is also performing another intended function, the sealing composition may result in the treatment fluid being self-diverting within the subterranean formation.

In some embodiments, the sealing composition may be injected into a subterranean formation following a hydraulic fracturing operation, in which case it may form a fluid seal that bridges the pore throats of a proppant pack previously formed in the near-wellbore region or to be formed in a far-field region of the treatment zone.

In other various embodiments, systems configured for delivering the sealing compositions of the present disclosure to a downhole location are described. In various embodiments, the systems can comprise a pump fluidly coupled to a tubular, the tubular containing a sealing composition comprising a plurality of degradable particulates and a plurality of water-insoluble microparticulates, the water-insoluble microparticulates being substantially non-degradable.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce a treatment fluid to a subterranean formation at or above a fracture gradient of the subterranean formation, but it may also be used in cases where fracturing is not desired. The sealing compositions described herein may be introduced with a high pressure pump, or they may be introduced following a treatment fluid that was introduced with a high pressure pump. In some embodiments, the high pressure pump may be capable of fluidly conveying particulate matter, such as proppant particulates or the particulate matter of the sealing compositions, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the sealing composition to the high pressure pump. In such embodiments, the low pressure pump may “step up” the pressure of the treatment fluid before it reaches the high pressure pump. Alternately, the low pressure pump may be used to directly introduce the sealing composition to the subterranean formation.

In some embodiments, the systems described herein can further comprise a mixing tank that is upstream of the pump and in which the sealing composition is formulated. In various embodiments, the pump (e.g., a low pressure pump, a high pressure pump, or a combination thereof) may convey the sealing composition from the mixing tank or other source of the sealing composition to the tubular. In other embodiments, however, the sealing composition can be formulated offsite and transported to a worksite, in which case the sealing composition may be introduced to the tubular via the pump directly from its shipping container (e.g., a truck, a railcar, a barge, or the like) or from a transport pipeline. In either case, the sealing composition may be drawn into the pump, elevated to an appropriate pressure, and then introduced into the tubular for delivery downhole.

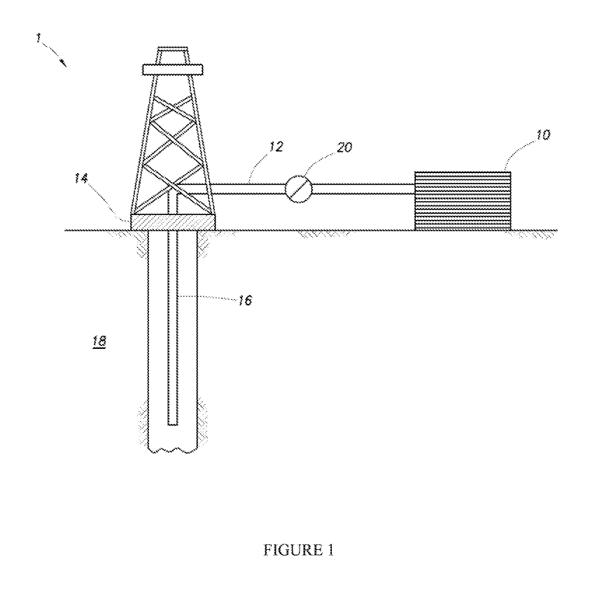

FIG. 1 shows an illustrative schematic of a system that can deliver sealing compositions of the present disclosure to a downhole location, according to one or more embodiments. It should be noted that while FIG. 1 generally depicts a land-based system, it is to be recognized that like systems may be operated in subsea locations as well. As depicted in FIG. 1, system 1 may include mixing tank 10, in which a sealing composition of the present disclosure may be formulated. The sealing composition may be conveyed via line 12 to wellhead 14, where the sealing composition enters tubular 16, tubular 16 extending from wellhead 14 into subterranean formation 18. Tubular 16 may include orifices that allow the sealing composition to enter into the subterranean formation. Upon being ejected from tubular 16, the sealing composition may subsequently penetrate into subterranean formation 18. Pump 20 may be configured to raise the pressure of the sealing composition to a desired degree before its introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensors, adapters, joints, gauges, sensors, compressors, pressure controllers, pressure sensors, flow rate controllers, flow rate sensors, temperature sensors, and the like.

Although not depicted in FIG. 1, the sealing composition may, in some embodiments, flow back to wellhead 14 and exit subterranean formation 18. In some embodiments, the sealing composition that has flowed back to wellhead 14 may subsequently be recovered and recirculated to subterranean formation 18. In other embodiments, the sealing composition may flow back to wellhead 14 in a produced hydrocarbon fluid from the subterranean formation.

It is also to be recognized that the disclosed sealing compositions may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

Embodiments disclosed herein include:

A. Methods comprising: providing a sealing composition comprising: a plurality of degradable particulates, and a plurality of water-insoluble microparticulates; introducing the sealing composition into a subterranean formation; and forming a degradable fluid seal with the sealing composition in the subterranean formation, the water-insoluble microparticulates being substantially non-degradable.

B. Methods comprising: combining in a carrier fluid a plurality of degradable particulates comprising a degradable polymer and a plurality of water-insoluble microparticulates, thereby forming a sealing composition; introducing the sealing composition into a subterranean formation; forming a degradable fluid seal with the sealing composition in the subterranean formation, the water-insoluble microparticulates being substantially non-degradable; performing a treatment operation in the subterranean formation while the degradable fluid seal is intact; and allowing the degradable fluid seal to degrade or performing a cleanup operation to degrade the degradable fluid seal.

C. Sealing compositions comprising: a plurality of degradable particulates, and a plurality of water-insoluble microparticulates.

D. Systems comprising: a pump fluidly coupled to a tubular, the tubular containing a sealing composition comprising: a plurality of degradable particulates, and a plurality of water-insoluble microparticulates; wherein the water-insoluble microparticulates are substantially non-degradable.

Each of embodiments A, B, C and D may have one or more of the following additional elements in any combination:

Element 1: wherein the degradable particulates comprise a degradable polymer.

Element 2: wherein the degradable polymer comprises at least one polymer selected from the group consisting of a polysaccharide, a protein, an aliphatic polyester, a polylactide, a polyglycolide, a poly(s-caprolactone), a poly(hydroxybutyrate), a polyanhydride, a poly(hydroxy ester ether), a poly(ether ester), a poly(ester amide), a polycarbamate, a polycarbonate, a poly(orthoester), a poly(amino acid), a poly(ethylene oxide), a polyphosphazene, polyvinyl alcohol, methyl cellulose, ethyl cellulose, carboxymethyl cellulose, carboxyethyl cellulose, acetyl cellulose, hydroxyethyl cellulose, shellac, dextran, guar, xanthan, starch, a scleroglucan, a diutan, poly(vinyl pyrollidone), polyacrylamide, polyacrylic acid, poly(diallyldimethylammonium chloride), poly(ethylene glycol), polylysine, polymethacrylamide, polymethacrylic acid, poly(vinylamine), any derivative thereof, any copolymer thereof, any salt thereof, and any combination thereof.

Element 3: wherein the degradable polymer comprises a polylactide or an aliphatic polyester.

Element 4: wherein the water-insoluble microparticulates have a particle size ranging between about 0.1 micron and about 150 microns.

Element 5: wherein the water-insoluble microparticulates have a Vickers hardness ranging between about 3 GPa and about 70 GPa.

Element 6: wherein the water-insoluble microparticulates comprise fly ash or are formed from fly ash.

Element 7: wherein the water-insoluble microparticulates comprise a particulate material selected from the group consisting of a silica flour, a ceramic microbody, a glass microbody, a microfiber having a diameter ranging between about 0.1 microns and about 150 microns, and any combination thereof.

Element 8: wherein the degradable particulates have a Vickers hardness of about 30 GPa or below.

Element 9: wherein the method further comprises performing a treatment operation in the subterranean formation while the degradable fluid seal is intact; and after performing the treatment operation, allowing the degradable fluid seal to degrade or performing a cleanup operation to degrade the degradable fluid seal.

Element 10: wherein the method further comprises allowing the degradable fluid seal to degrade or performing a cleanup operation to degrade the degradable fluid seal; and producing at least a portion of the water-insoluble microparticulates from the subterranean formation in a produced fluid.

Element 11: wherein the sealing composition is introduced into the subterranean formation in a pad fluid or a pill, and the method further comprises introducing a treatment fluid into the subterranean formation subsequent to the pad fluid or the pill.

Element 12: wherein the method further comprises diverting the subsequently introduced treatment fluid with the degradable fluid seal.

Element 13: wherein the sealing composition is introduced into the subterranean formation in a treatment fluid that is used in performing the treatment operation.

Element 14: wherein the method further comprises after allowing the degradable fluid seal to degrade or performing a cleanup operation to degrade the degradable fluid seal, producing at least a portion of the water-insoluble microparticulates from the subterranean formation in a produced fluid.

Element 15: wherein the carrier fluid further comprises a crosslinked polymer.

By way of non-limiting example, exemplary combinations applicable to A, B, C and D include:

The method of A or B in combination with elements 1, 2 and 5.

The method of A or B in combination with elements 5 and 8.

The method of A or B in combination with elements 1, 3 and 4.

The method of A or B in combination with elements 1, 2 and 7.

The method of A or B in combination with elements 1, 2 and 8.

The method of A or B in combination with elements 5 and 10.

The method of A or B in combination with elements 5 and 11.

The method of A or B in combination with elements 5 and 12.

The method of A or B in combination with elements 5 and 13.

The sealing composition of C in combination with elements 1, 2 and 4.

The sealing composition of C in combination with elements 1, 2 and 5.

The sealing composition of C in combination with elements 5 and 8.

The system of D in combination with elements 1, 2 and 4.

The system of D in combination with elements 1, 2 and 5.

To facilitate a better understanding of the embodiments of the present disclosure, the following examples of preferred or representative embodiments are given. In no way should the following examples be read to limit, or to define, the scope of the disclosure.

### EXAMPLES

### Example 1

A 30 lb/Mgal (Mgal=thousand gallons) carboxymethylhydroxyethyl cellulose (CMHEC) fluid was formulated in 12.5 ppg NaBr brine. The linear fluid pH was then adjusted to 4.8 by addition of a buffer agent (BA-20, available from Halliburton Energy Services). Various additives were then introduced to this fluid phase, as specified in Table 1 (Entries 2-6). After introduction of the additives, the CMHEC was crosslinked using CL-40 crosslinker (a Zr-based crosslinker available from Halliburton Energy Services). The CMHEC from Example 1 was also crosslinked in a similar manner. Delayed breakers (Vicon NF and Optiflo HTE) were added to the fluids in order to compare fluid loss effects both before and after deviscosification of the carrier fluid.

TABLE 1

| | | Spurt Loss^{a} | |
|---|---|---|---|
| Entry | Fluid Composition | (gal/ft²) | C_{w}^{b} (ft/min^{1/2}) |
| 1 | 30 lbs/Mgal CMHEC (control) | 2.39 | 0.17 |
| 2 | 1:1 mixture of 1 ppg | 0.51 | 0.004 |
| | PLA^{c}:microparticulates^{d} | | |
| | (in crosslinked gel) | | |
| 3 | 1:1 mixture of 1 ppg | 8.82 | 0.90 |
| | PLA:microparticulates | | |
| | (24 hours of aging, gel | | |
| | broken) | | |
| 4 | 1.5 ppg PLA (in crosslinked | 1.10 | 0.037 |
| | gel) | | |
| 5 | 1.5 ppg PLA (24 hours of | 3.83 | 2 × 10⁻¹⁵ |
| | aging, gel broken) | | |
| 6 | 2.3 ppg microparticulates | 0.78 | 0.012 |
| | (in crosslinked gel) | | |

^{a}Spurt loss is the instantaneous volume of fluid that passes through a given area of a porous medium before deposition of a filter cake thereon to stem the fluid flow.
^{b}C_{w} is the continuous leak off rate of a fluid through an established filter cake that is disposed on a porous medium.
^{c}PLA = polylactic acid
^{d}microparticulates = N-1200 ZEEOSPHERES (silica-alumina microspheres having a d₉₅ of about 150 microns or less, available from Zeeospheres Ceramics LLC)

The fluid loss properties of the fluids were then tested at the indicated time shown in Table 1 using an aloxite disk having a mean pore diameter of 90 microns and an air permeability of 13.5 darcies. Testing results of the spurt loss and combined leak rate are shown in Table 1. The aloxite disk was placed at the lower end of a 500 mL high temperature high pressure cell closest to the perforation hole. Approximately 400 mL of each sample was placed directly on the disk, and a differential pressure of 500 psi was applied while fluid loss rates were monitored versus changes in pressure. Pressure was applied with a supply of nitrogen gas. After testing, the aloxite disk was removed from the testing apparatus, and the filter cake was observed visually.

As shown by comparing Entry 2 with Entries 4 and 6 in Table 1, the combination of PLA and microparticulates produced significantly better fluid loss properties than did either of these particulate materials acting alone at higher concentrations. Moreover, as shown by comparing Entries 3 and 5, the microparticulates did not significantly impact the breaking process of either the viscosified carrier fluid or the PLA. Specifically, Entries 3 and 5 showed restoration of flow after a suitable shut in time.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The disclosure illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A method comprising:
providing a sealing composition comprising:
a plurality of degradable particulates, and
a plurality of water-insoluble, substantially non-degradable microparticulates;
introducing the sealing composition into a subterranean formation; and
forming a degradable fluid seal with the sealing composition in the subterranean formation.

2. (canceled)

3. The method of claim 1, wherein the degradable particulates comprise a degradable polymer selected from the group consisting of a polysaccharide, a protein, an aliphatic polyester, a polylactide, a polyglycolide, a poly(ε-caprolactone), a poly(hydroxybutyrate), a polyanhydride, a poly(hydroxy ester ether), a poly(ether ester), a poly(ester amide), a polycarbamate, a polycarbonate, a poly(orthoester), a poly(amino acid), a poly(ethylene oxide), a polyphosphazene, polyvinyl alcohol, methyl cellulose, ethyl cellulose, carboxymethyl cellulose, carboxyethyl cellulose, acetyl cellulose, hydroxyethyl cellulose, shellac, dextran, guar, xanthan, starch, a scleroglucan, a diutan, poly(vinyl pyrollidone), polyacrylamide, polyacrylic acid, poly(diallyldimethylammonium chloride), poly(ethylene glycol), polylysine, polymethacrylamide, polymethacrylic acid, poly(vinylamine), any derivative thereof, any copolymer thereof, any salt thereof, and any combination thereof.

4. (canceled)

5. (canceled)

6. The method of claim 1, wherein the water-insoluble microparticulates have a Vickers hardness ranging between about 3 GPa and about 70 GPa and a particle size ranging between about 0.1 micron and about 150 microns.

7. The method of claim 1, wherein the water-insoluble microparticulates comprise fly ash or are formed from fly ash.

8. The method of claim 1, wherein the water-insoluble microparticulates comprise a particulate material selected from the group consisting of a silica flour, a ceramic microbody, a glass microbody, a microfiber having a diameter ranging between about 0.1 microns and about 150 microns, and any combination thereof.

9. The method of claim 1, wherein the degradable particulates have a Vickers hardness of about 30 GPa or below.

10. The method of claim 1, further comprising:
performing a treatment operation in the subterranean formation while the degradable fluid seal is intact; and
after performing the treatment operation, allowing the degradable fluid seal to degrade or performing a cleanup operation to degrade the degradable fluid seal.

11. The method of claim 1, further comprising:
allowing the degradable fluid seal to degrade or performing a cleanup operation to degrade the degradable fluid seal; and
producing at least a portion of the water-insoluble microparticulates from the subterranean formation in a produced fluid.

12. A method comprising:
combining in a carrier fluid a plurality of degradable particulates comprising a degradable polymer and a plurality of water-insoluble, substantially non-degradable microparticulates, thereby forming a sealing composition;
introducing the sealing composition into a subterranean formation;
forming a degradable fluid seal with the sealing composition in the subterranean formation;
performing a treatment operation in the subterranean formation while the degradable fluid seal is intact; and
allowing the degradable fluid seal to degrade or performing a cleanup operation to degrade the degradable fluid seal.

13. The method of claim 12, wherein the sealing composition is introduced into the subterranean formation in a pad fluid or a pill, the method further comprising:
introducing a treatment fluid into the subterranean formation subsequent to the pad fluid or the pill.

14. The method of claim 13, further comprising:
diverting the subsequently introduced treatment fluid with the degradable fluid seal.

15. (canceled)

16. The method of claim 12, wherein the degradable polymer comprises at least one polymer selected from the group consisting of a polysaccharide, a protein, an aliphatic polyester, a polylactide, a polyglycolide, a poly(ε-caprolactone), a poly(hydroxybutyrate), a polyanhydride, a poly(hydroxy ester ether), a poly(ether ester), a poly(ester amide), a polycarbamate, a polycarbonate, a poly(orthoester), a poly(amino acid), a poly(ethylene oxide), a polyphosphazene, polyvinyl alcohol, methyl cellulose, ethyl cellulose, carboxymethyl cellulose, carboxyethyl cellulose, acetyl cellulose, hydroxyethyl cellulose, shellac, dextran, guar, xanthan, starch, a scleroglucan, a diutan, poly(vinyl pyrollidone), polyacrylamide, polyacrylic acid, poly(diallyldimethylammonium chloride), poly(ethylene glycol), polylysine, polymethacrylamide, polymethacrylic acid, poly(vinylamine), any derivative thereof, any copolymer thereof, any salt thereof, and any combination thereof.

17. (canceled)

18. The method of claim 12, further comprising:
after allowing the degradable fluid seal to degrade or performing a cleanup operation to degrade the degradable fluid seal, producing at least a portion of the water-insoluble microparticulates from the subterranean formation in a produced fluid.

19. The method of claim 12, the water-insoluble microparticulates have a particle size ranging between about 0.1 micron and about 150 microns.

20. The method of claim 12, wherein the water-insoluble microparticulates comprise fly ash or are formed from fly ash.

21. The method of claim 12, wherein the water-insoluble microparticulates comprise a particulate material selected from the group consisting of a silica flour, a ceramic microbody, a glass microbody, a microfiber having a diameter ranging between about 0.1 microns and about 150 microns, and any combination thereof.

22. The method of claim 12, wherein the water-insoluble microparticulates have a Vickers hardness ranging between about 3 GPa and about 70 GPa.

23. The method of claim 22, wherein the degradable particulates have a Vickers hardness of about 30 GPa or below.

24. (canceled)

25. A sealing composition comprising:
a plurality of degradable particulates, and
a plurality of water-insoluble, substantially non-degradable microparticulates.

26. (canceled)

27. The method of claim 1, further comprising a tubular extending into the subterranean formation and a pump fluidly coupled to the tubular, the tubular containing a sealing composition comprising: a plurality of degradable particulates, and, a plurality of water-insoluble, substantially non-degradable microparticulates.
